(19) United States
(12) Patent Application Publication
(10) Pub. No.: US 2007/0240611 A1
(43) Pub. Date: Oct. 18, 2007

(54) High Strength Ascon Composition Comprising Slag Ball and Method for Producing the Same

(76) Inventors: Ok-Soo Oh, Seoul (KR); Sang Yoon Oh, Seoul (KR)

Correspondence Address: MCDERMOTT WILL & EMERY LLP, 18191 VON KARMAN AVE., SUITE 500, IRVINE, CA, 92612-7108, US

(21) Appl. No.: 11/579,841

(22) PCT Filed: May 4, 2005
(86) PCT No.: PCT/KR05/01291

§ 371 Date: Nov. 7, 2006

(30) Foreign Application Priority Data
May 8, 2004 (KR) 10-2004-0032472

(51) Int. Cl. C04B 18/14; C08L 95/00

(52) U.S. Cl. 106/281.1

(57) ABSTRACT

Provided are ASCON utilizing atomized slag as fine aggregates and a method for producing the same. More particularly, provided are ASCON composition that is improved in strength by substituting all or part of fine aggregates for atomized slag and a method for producing the same. ASCON composition includes coarse aggregates, fine aggregates, fillers, and asphalt. When the fine aggregates is 100 parts by weight, the fine aggregates include 0-70 parts by weight of atomized slag balls having a diameter of less than 5mm. Accordingly, it is possible to obtain the ASCON composition that has large strength and can greatly reduce a heating temperature in the mixing operation.

### TECHNICAL FIELD

The present invention relates to ASCON utilizing atomized slag as fine aggregates and a method for producing the same, and more particularly, to ASCON composition that is improved in strength by substituting all or part of fine aggregates with atomized slag and a method for producing the same.

### BACKGROUND ART

ASCON is an abbreviated word of asphalt concrete that is used as a road pavement material, which is formed by mixing fine aggregates, coarse aggregates and fillers with asphalt that is a by-product obtained in the manufacture of petroleum.

An example of conventional ASCON includes 8 wt % sand and 50 wt % stone powder as fine aggregates, 33 wt % gravel as coarse aggregates, 3 wt % fillers, and 6 wt % asphalt.

The fine aggregates, the coarse aggregates, and the fillers are mixed in a proper ratio to properly maintain the strength of the ASCON and minimize pores.

As described above, as the aggregates, the sand, stone powder and gravel that can be obtained from natural resources have been used. However, the obtainment of the aggregates from the natural resources causes the environment destruction and the natural resources are gradually drained, there is limitation in extracting the aggregates from the natural resources. Therefore, it has been intensively required to develop substituting aggregates.

Accordingly, a variety of substituting aggregates have been developed. For example, a technology using blast furnace slag (Korean Patent Laid-Open Publication No. 1997-0026990), water quenched blast furnace slag (Korean Patent Laid-Open Publication No. 1996-0022346), converter slag (Korean Patent Laid-Open Publication No. 1997-0026991), or a waste casting sand (Korean Patent No. 10-0357669) has been developed. Since the aggregates disclosed in the patents exist in the form of a lump, there is a need for a process for grinding and size classification of the aggregates to make standard fine and coarse aggregates appropriate to use in ASCON. In addition, the aggregates disclosed in the reference have low strength. Furthermore, due to the hydration of a free lime contained in the aggregates, an aging process should be performed for 1-2 months, and it is very difficult to obtain desirable strength (desirable stability) of the aggregates.

### DISCLOSURE OF INVENTION

Technical Problem

Therefore, it is an object of the present invention to provide ASCON composition that can solve the natural aggregates extraction problem by substituting part of fine aggregates for atomized slag balls and is improved in strength without an additional treatment as compared with conventional ASCON composition and a method for producing such ASON composition.

It is another object of the present invention to provide ASCON composition that makes it easy to perform the road paving work by providing sufficient fluidity at a relatively low tapping temperature as compared with conventional ASON composition.

Technical Solution

To achieve the above objects, the present invention provides an ASCON composition including coarse aggregates, fine aggregates, fillers, and asphalt, wherein when the fine aggregates is 100 part by weight, the fine aggregates include 0-70 parts by weight of atomized slag balls having a diameter of less than 5 mm.

Preferably, the fine aggregates further includes 30-95 parts by weight of stone powder and a sand such that a mixture of the sand and the slag ball mixture has 5-25 parts by weight when the slag ball is less than 25 parts by weight.

The slag ball may be greater than 15 parts by weight when the fine aggregates is 100 part by weight.

The slag balls may be formed of a converter slag or an electric arc furnace slag.

The converter slag or electric arc furnace slag may include 14.5-63 wt % of CaO, 22-45 wt % of Fc₂O₃, 10-22 wt % of SiO₂, 6˜10 wt % of MgO, less than 3 wt % of FcO, less than 5.5 wt % of Al₂O₃, and other impurities.

The ASCON composition may include 17-38 wt % of coarse aggregates, 40-65 wt % of fine aggregates, 1-8 wt % of fillers, 2-10 wt % of asphalt, and other inevitable impurities.

According to another aspect of the present invention, there is provided a method for producing an ASCON composition, the method including: preparing slag balls, sand, stone powder, and fillers in respective hoppers; feeding the slag balls, sand, stone powder, and fillers to a mixing machine according to the composition ratio defined above; storing and heating asphalt independently from the preparing step and the feeding step; feeding the asphalt to the mixing machine according to the composition ratio defined above; mixing the slag balls, sand, stone powder, fillers, and asphalt; and

heating the mixture at a temperature of 110-140° C.

Advantageous Effects

According to the present invention, by substituting part of the fine aggregates with slag balls, additional treatments is not required to produce ASCON composition as compared to produce the conventional ASCON containing artificial aggregates. In addition, the inventive ASCON composition makes it easy to perform a tapping and paving works by obtaining sufficient fluidity at a relatively low tapping temperature as compared with prior ASCON composition.

### BRIEF DESCRIPTION OF THE DRAWINGS

FIG. 1 is a flowchart illustrating a method for producing a high strength ASCON composition according to an embodiment of the present invention.

### BEST MODE FOR CARRYING OUT THE INVENTION

ASCON composition includes coarse aggregates, fine aggregates, fillers, asphalt, and other inevitable impurities, when the fine aggregates is 100 part by weight, the fine aggregates include 0-70 parts by weight (not including 0 part by weight) of atomized slag balls having a diameter of less than 5 mm.

As described in the background art, the conventional ASCON composition includes fine aggregates mainly formed of natural sands. However, due to the extraction limitation of the natural sands as well as the environment destruction, there has been a limitation in using the natural sands as the fine aggregates for the ASCON composition. Furthermore, the improvement in strength (stability) of ASCON composition has been continuously required.

Therefore, a variety of substitutes for all or part of the fine aggregates of the conventional ASCON have been proposed. However, the substitutes have not met a physical property required for the fine aggregates used in ASCON or there is a need to a specific pre-process to use the substitutes as the fine aggregates. That is, it is difficult to produce ASCON containing the substituting aggregates. Furthermore, the ASCON containing the substituting aggregates is deteriorated in a required physical property as compared with the conventional ASCON.

In order to solve the above problems, the inventors of this application have studied to develop ASCON composition that has a physical property such as strength and the like, which is better than that of the conventional ASCON composition. As a result, it is found that, when the fine aggregates of the ASCON composition are substituted with atomized slag balls, such problems of the prior art can be solved.

The slag balls that will be contained in the inventive ASCON composition are atomized slag balls. In the atomizing process, converter slag or electric arc furnace slag that is molten and contained in a slag pot or other container is dropped downward, in the course of which gas and/or mixture gas containing water is sprayed on the dropping slag, thereby separating the slag into fine liquid drops. That is, the dripping slag have surface energy required for forming the fine liquid drops by receiving kinetic energy from the mixture gas.

The fine liquid drops formed by the above-described atomizing process are formed in a spherical-shape due to surface tension, after which they are cooled by a cooling medium such as air or water, thereby being formed in solid slag balls. Such solid slag balls have a physical property totally different from that of the lump converter slag or electric arc furnace slag that are treated through a slow cooling process. That is, the conventional converter slag or electric slag contains a large amount of free lime (CaO).

The CaO reacts with water to form Ca(OH). Therefore, the slag is increased in a volume, as a result of which it may be powdered. However, the slag balls contained in the inventive ASCON composition contains few free lime (CaO), there is no possibility that they are powdered.

Unlike the ASCON containing the conventional substituting fine aggregates, the ASCON containing the fine aggregates formed of the atomized slag balls can be improved in strength and fluidity without going through additional treatments.

The improvement is caused by the properties of the atomized slag balls as follows:

Particle-Size Distribution

Table 1 shows a result of comparison of the particle size of fine aggregates, which is required by Korean Standard (KSF-2357), with that of the slag balls. As can be noted from Table 1, since the slag balls are atomized, the particle size thereof is finely and uniformly distributed, providing an improved property as the fine aggregates. Accordingly, in the case of the slag balls, there is no need of an addition treatment adjusting properly the particle size.

TABLE 1

Amount Passing Through Screen (%)

| Size of Screen (mm) | KS Standard (No. 3) | Slag Balls |
|---|---|---|
| 5 | 100 | 100 |
| 2.5 | 95-100 | 100 |
| 1.2 | 85-100 | 95 |
| 0.6 | 65-90 | 80 |
| 0.3 | 30-60 | 52 |
| 0.15 | 5-25 | 17 |
| 0.08 | 0-5 | 3 |

Hardness

The slag balls may be formed of converter slag or electric arc furnace slag. Although the composition of the converter slag and the composition of the electric arc furnace slag may be changed depending on a type of produced steel, it is generally as shown in the following Table 2.

TABLE 2

| | Compounds | | | | | |
|---|---|---|---|---|---|---|
| | CaO | Fe₂O₃ | SiO₂ | MgO | FeO | Al₂O₃ |
| Composition(wt %) | 14-63 | 22-45 | 10-20 | 6-10 | ≦3 | ≦5.5 |

The slag formed of the above composition may contain a variety of compounds such as 2CaO.Fe₂O₃, 3CaO.Fe₂O, MgO.Al₂O₃ and 3CaO.SiO₂ . The compounds is stable and high in hardness. Particularly, the MgO.Al₂O₃ has a very stable material that is called spinel, thereby going far toward increasing the hardness of the slag balls. Accordingly, the slag balls have very high hardness of about 6.5-8.0 Mohs hardness and 500-700 Vickers hardness.

Heavy Metal Elution

Since the ASCON is generally used for paving the road, it is frequently exposed to water such as rain water or snow. Therefore, when the ASCON contains a heavy metal, the heavy metal may be eluted to the water and directed to the drain and neighboring soil. Therefore, the aggregates used for ASCON should not contain the heavy metal. As can be noted from the following Table 3, no heavy metal is contained in the slag balls of the present invention.

TABLE 3

| | Restricted Material | | | | | | |
|---|---|---|---|---|---|---|---|
| | Pb | Cu | As | Hg | Cd | Cr | CN |
| Permissible | Below | Below | Below | Below | Below | Below | Below |
| Dose(ppm) | 3.0 | 3.0 | 1.5 | 0.005 | 0.3 | 1.5 | 1.0 |
| Test | Not | Not | Not | Not | Not | Not | Not |
| Result(ppm) | Detected | Detected | Detected | Detected | Detected | Detected | Detected |

Other Properties

As can be noted from the following Table 4, the specific gravity and the compressive strength are very high as compared with sand. Water absorption rate is reduced to ⅙ of the sand. Therefore, it can be noted that the slag balls are proper to the conditions of the ASCON that should have a low water absorption rate.

In addition, the shape coefficient means that, when it is 1, a shape of the slag ball appears the perfect spherical-shape. As noted from Table 4, the shape coefficient of the inventive slag ball is 0.95, that means the shape thereof is almost spherical. When the shape of the slag ball is closer to the perfect spherical-shape, the resistance of the asphalt can be minimized, enhancing the mixture of the slag balls with the asphalt.

As can be noted from Table 1, the slag balls meet the particle-size distribution of the fine aggregates, which is required by Korean Stand. Furthermore, as can be noted from Table 4, the uniformity coefficient of the particle size of the inventive slag balls is 1.22, which means that the particle-size distribution is very uniform (When the uniformity coefficient is 1, it means that all particles are identical in a size to each other).

TABLE 4

| Actual | Appearance | | | | | |
|---|---|---|---|---|---|---|
| Specific | Specific | Water | Compressive | | | |
| Gravity(g/ | Gravity(g/ | Absorption | Strength(kg/ | Shape | Uniformity | Angle |
| cm³) | cm³) | rate(%) | cm2) | Coefficient | Coefficient | ofRepose |
| 3.54 | 2.12 | 0.1 | 223 | 0.95 | 1.22 | 14˜18° |

When the ASCON is produced by substituting all or part of fine aggregates with the slag balls, the ASCON is designed to be improved in strength and hardness while avoiding the heavy metal pollution. Since the slag ball contains an iron oxide, the color thereof is black. Therefore, when the slag balls are used as the road paving material, the color can maintain for a long time.

In order to realize the above described effects, it is preferable that when the fine aggregates are 100 parts by weight, the slag ball is 0-70 parts by weight (not including 0). When the slag ball is more than 70 parts by weight, the road surface paved with the ASCON may get stripped off. Since the physical property such as the strength and hardness of the ASCON is increasingly improved until the slag ball becomes 70 parts by weight, there is no need of limiting the lowest content of the slag balls. A heating temperature can be lowered by improving the fluidity by optimally forming the shape of the slag ball and improving the density during producing the ASCON composition. In order to realize this, it is preferable that slag ball is more than 15 parts by weight.

It is preferable that the inventive ASCON composition comprises 17-38 wt % coarse aggregates, 40-65 wt % fine aggregates, 1-8 wt % fillers, 2-10 wt % asphalt, and other inevitable impurities. This will be described in more detail hereinafter.

Fine Aggregates: 40-65 wt %

Fine aggregates function to fill pores between the coarse aggregates and to provide strength. When the fine aggregates are provided to be more than 65 wt %, the pores required for the asphalt pavement are excessively reduced and the strength is reduced.

When the fine aggregates are provided to be less than 40 wt %, the pores are excessively increased, as a result of which the air and water may be easily permeated into pores, thereby making the road surface may get stripped off. Therefore, it is preferable that the wt % of the fine aggregates is about 40-65 wt %.

The fine aggregates include sand and stone powder as well as the slag balls. At this point, when the content of the slag ball is less than 25 parts by weight, it is preferable that the mixture of the sand and the slag balls is less than 5-25 parts by weight and the stone powder is 30-95 parts by weight.

When the mixture of the sand and the slag balls is less than 5 wt %, the road surface paved with the ASCON may be uneven. Meanwhile, when the mixture of the sand and the slag balls exceeds 25 wt %, the road surface paved with the ASCON may get stripped off.

Coarse Aggregates: 17-38 wt %

In the ASCON composition, coarse aggregates are the largest together with the fine aggregates. The coarse and fine aggregates are complementary in their mixing rate. That is, when a large amount of the fine aggregates is mixed, a small amount of the coarse aggregates is mixed. Therefore, the coarse aggregates are less than 17 wt %, a variety of problems such as the pore reduction, unevenness of the road surface, and strength reduction are incurred. When the coarse aggregates are more than 33 wt %, a variety of problems such as water permeation and surface stripping off are incurred.

Fillers: 1-8 wt %

The fillers function to control the pore rate of the ASCON composition. The paved ASCON requires generally 3-6% pore rate. Therefore, it is preferable that the content of fillers in the ASCON is 1-8 wt %. It is further preferable that the fillers satisfy Korean Standard KSF-3501.

Asphalt: 2-10 wt %

The Asphalt functions to provide binding force and fluidity of the ASCON composition to make it easy to perform the paving process. When the content of asphalt in the ASCON is less than 2 wt %, the binding force and fluidity are weakened. When the content of asphalt in the ASCON is higher than 10 wt %, the strength of the ASCON is weakened. Therefore, it is preferable that the content of asphalt in the

ASCON is 2-10 wt %.

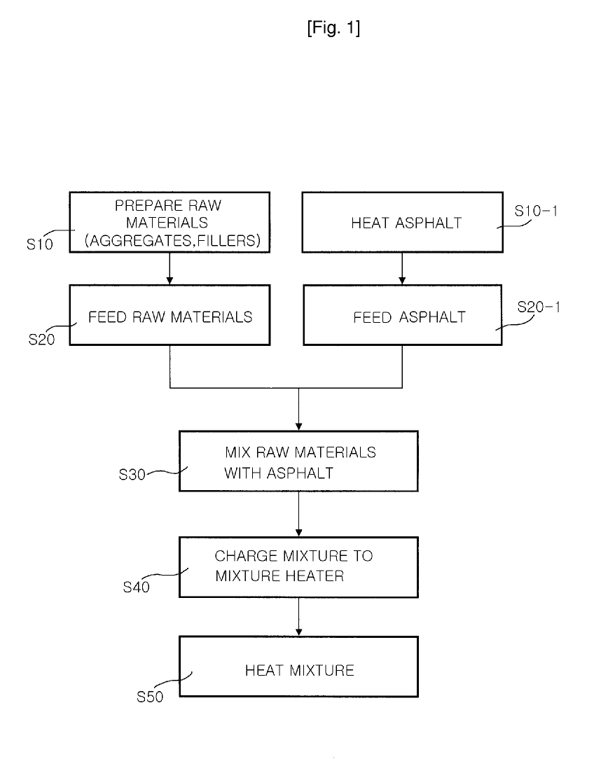

A method for producing the inventive ASCON composition will be described hereinafter with reference to FIG. 1.

FIG. 1 shows a flowchart illustrating a method for producing ASCON using special steel manufacture slag.

(1) Slag balls, sand, stone powder, coarse aggregates, and fillers are charged into respective hoppers (S10). To use conventional substituting aggregates as the fine aggregates, a vareity of pre-treatments such as prescription, grinding and size classification processes have been required. However, no pre-treatment is required for the inventive slag balls.

(2) Next, the slag balls, sand, stone powder, coarse aggregates, and fillers that are s tored in the respective hoppers are fed to a mixing machine by respective amounts proper for the ASCON composition (S20). Preferably, the materials are discharged from the respective hoppers and transferred to a main conveyer belt through respective independent conveyer belts. The materials transferred to the main conveyer belt is inputted to the mixing machine.

(3) In addition to the material feeding process (S20), the asphalt is prepared at a temperature proper for mixing with the materials (S 10-2) and is then fed into the mixing machine by a predetermined amount required for producing the ASCON.

(4) The materials and the asphalt are mixed by agitation of the mixing machine (S30).

(5) The mixture is inputted to a mixture heater (S40).

(6) The mixture is heated by heat generated from a burner (S50). At this point, a temperature of the mixture is maintained at 110-140° C. The heating temperature is the most important feature of the present invention. That is, in the prior art, the heating temperature is higher than 160° C. to provide sufficient fluidity to the mixture. However, in the present invention, even when the heating temperature is less than 140° C., since the slag balls are formed in a spherical-shape while having high specific gravity, the mixture can be sufficiently mixed well. Therefore, the maintained temperature of the mixture can be lowered and the energy costs can be saved.

The heated mixture can be used for paving the road through a storage and output processes.

### Mode for the Invention

### Embodiment 1

ASCON is produced by using gravels as the coarse aggregates and slag balls and stone powder as the fine aggregates and is then tested. That is, the ASCON composition includes 33 wt % of gravels, 60.5 wt % of fine aggregates, 2 wt % of fillers, and 4.5 wt % of asphalt. When the fine aggregates are 100 parts by weight, the slag ball is 59 parts by weight and the stone powder having a size less than 5mm is 41 parts by weight.

The test results of the ASCON are shown in the following Table 5. The Prior Art of Table 5 is a result for using 15 parts by weight of washed sands and 85 parts by weight of stone powder when the fine aggregates are 100 parts by weight.

TABLE 5

| | KS Standard | Embodiment 1 | Prior Art |
|---|---|---|---|
| Fineness Modulus | 1.95-6.43 | 2.60 | 3.04 |
| Density(g/cm³) | Above 2.3 | 3.48 | 2.60 |
| Water Absorption | Below 5 | 0.1 | 0.6 |
| Rate(%) | | | |
| Stability(kgf) | Above 600 | 1327 | 1245 |
| Fluidity(1/100 cm) | 20-40 | 26 | 35 |
| Pore Rate(%) | 3-6 | 4.39 | 5.13 |
| Degree of | 70-85 | 75.46 | 71.76 |
| Saturation(%) | | | |

As can be noted from Table 5, the stability of the inventive ASCON composition is 1327 kgf while the stability of prior ASCON composition using sand (washed sand) is 1245 kgf. This means that the strength of the inventive ASCON composition is remarkably higher than that of the prior ASCON composition.

In addition, the ASCON of this example is improved to meet KS standards with regards to the fineness modulus, density, water absorption rate, fluidity, pore rate, and degree of saturation.

### Embodiment 2

ASCON composition including 33 wt % of gravels, 60.5 wt % of fine aggregates, 2 wt % of fillers, and 4.5 wt % of asphalt is produced. When the fine aggregates are 100 parts by weight, the slag ball is 34 parts by weight and the stone powder having a size less than 5mm is 66 parts by weight. The ASCON of this example is improved in strength having 1289 kgf higher than that (1245 kgf) of the prior art. The fluidity of the ASCON of this example is 31 meeting the KS standard.

To identify the lowest heating temperature of the ASCON of this example, it is noted by performing the mixture heating while varying the temperature that the mixture heating is possible at a temperature higher than 110° C.

1. An ASCON composition comprising coarse aggregates, fine aggregates, fillers, and asphalt,
wherein when the fine aggregates are 100 parts by weight, the fine aggregates include 0-70 parts by weight of atomized slag balls having a diameter of less than 5mm.

2. The ASCON composition of claim 1, wherein the fine aggregates further comprises stone powder and sand, the stone powder being 30-95 parts by weight, a sand/slag ball mixture being 5-25 parts by weight when the slag ball is less than 25 parts by weight.

3. The ASCON composition of claim 1, wherein the atomized slag ball is greater than 15 parts by weight.

4. The ASCON composition of any one of claims 1 to 3, wherein the slag balls are formed of converter slag or electric arc furnace slag.

5. The ASCON composition of claim 4, wherein the converter slag or electric arc furnace slag comprises 14.5-63 wt % of CaO, 22-45 wt % of Fe₂O₃, 10-22 wt % of SiO₂, 6˜10 wt % of MgO, less than 3 wt % of FeO, less than 5.5 wt % of Al₂O₃, and other impurities.

6. The ASCON composition of any one of claims 1 to 3, wherein the ASCON composition comprises 17-38 wt % of coarse aggregates, 40-65 wt % of fine aggregates, 1-8 wt % of fillers, 2-10 wt % of asphalt, and other inevitable impurities.

7. A method for producing ASCON composition comprising:
preparing slag balls, sand, stone powder, and fillers in respective hoppers;
feeding the slag balls, sand, stone powder, and fillers to a mixing machine according to the composition ratio set forth in claim 6;
storing and heating asphalt independently from the preparing step and the feeding step;
feeding the asphalt to the mixing machine according to the composition ratio set forth in claim 6;
mixing the slag balls, sand, stone powder, fillers, and asphalt; and
heating the mixture at a temperature of 110-140° C.
